(19) United States
(12) Patent Application Publication
(10) Pub. No.: US 2026/0324629 A1
(43) Pub. Date: Oct. 22, 2026

(54) COMPOSITE PANEL WITH PERSISTENT ANTIBACTERIAL AND STERILIZING FUNCTION AND PREPARATION METHOD THEREOF

(71) Applicant: Great Apex Industrial Factory Limited, HongKong (CN)

(72) Inventor: Yuetong ZHAO, HongKong (CN)

(73) Assignee: Great Apex Industrial Factory Limited, HongKong (CN)

(21) Appl. No.: 19/263,584

(22) Filed: Jul. 9, 2025

(30) Foreign Application Priority Data
Apr. 16, 2025 (CN) 2025104779662

(51) Int. Cl. A01N 25/10; A01N 25/34; A01N 59/00; A01N 59/16; A01P 1/00

(52) U.S. Cl. CPC A01N 25/10; A01N 25/34; A01N 59/00; A01N 59/16; A01P 1/00

(57) ABSTRACT

Disclosed is a composite panel with persistent antibacterial and sterilizing functions and a preparation method thereof. By optimizing the formula of the antibacterial functional layer, the problems of poor adhesion and easy loss of antibacterial components are solved, and the bonding strength between the antibacterial layer and the substrate is significantly improved. Broad-spectrum antibacterial performance is achieved, and food safety standards are met. The composite panel still maintains an antibacterial rate of more than 95% after 100 cleaning cycles, demonstrating excellent durability. The preparation method includes preparation of raw materials, preparation of an antibacterial functional layer, substrate surface treatment and composite processing. The process has strong compatibility and is particularly suitable for surface protection of bathroom appliances, pet products, and household products. Therefore, the present invention has a strong market potential.

### CROSS-REFERENCE TO RELATED APPLICATIONS

The application claims priority to Chinese patent application No. 2025104779662, filed on Apr. 16, 2025, the entire contents of which are incorporated herein by reference.

### TECHNICAL FIELD

The present invention relates to the technical field of new composite material manufacturing, and in particular to a composite panel with persistent antibacterial and sterilizing functions and a preparation method thereof.

### BACKGROUND

In the prior art, the main preparation methods of antibacterial panels include the following:
Surface spraying antibacterial agent process: The antibacterial function is realized by spraying an antibacterial agent on the surface of the panel, but problems such as poor coating adhesion and easy loss of antibacterial components lead to difficult durability of antibacterial performance.
Antibacterial masterbatch mixing process: Antibacterial panels are prepared by mixing an antibacterial masterbatch with a substrate, but this method may cause degradation of mechanical properties of the material, affecting the panel performance.
Bonding process of antibacterial layer and substrate in composite panels: In the prior art, the bonding strength between the antibacterial layer and the substrate is insufficient, which is difficult to meet the use requirements of high-frequency contact scenarios. Especially, the antibacterial layer is easy to fall off during cleaning or friction.

The above problems limit the promotion of existing antibacterial panels in practical applications. Therefore, there is a need for a new type of antibacterial composite panel and a preparation method thereof that can solve the above defects.

### SUMMARY

The present invention aims to solve at least one of the technical problems existing in the prior art. For this purpose, the present invention provides a composite panel with persistent antibacterial and sterilizing functions and a preparation method thereof, which can improve the bonding strength between the antibacterial layer and the substrate, realize broad-spectrum antibacterial performance, and meet food safety requirements. The composite panel still maintains an antibacterial rate of more than 95% after 100 cleaning cycles, demonstrating excellent durability. The preparation method includes raw material preparation, antibacterial functional layer preparation, substrate surface treatment, and composite processing, with strong process compatibility, and is particularly suitable for surface protection of bathroom appliances, pet products, and household products; therefore, the present invention has a significant market application value and promotion prospects.

A composite panel with persistent antibacterial and sterilizing functions according to embodiments of the first aspect of the present invention, including: a substrate and an antibacterial functional layer; the antibacterial functional layer is composed of the following components mixed in percentage by weight: 1-5% of a nanosilver composite, 3-8% of a titanium dioxide photocatalyst, 85-95% of a polyurethane/acrylic resin matrix, and 0.5-2% of a silane coupling agent.

According to some embodiments of the present invention, the substrate is a metal substrate or a non-metal substrate, the metal substrate includes a stainless steel and an aluminum alloy, and the non-metal substrate includes a wood and a density board.

According to embodiments of the present invention, a composite panel with persistent antibacterial and sterilizing functions has at least the following beneficial effects: By optimizing the formula of the antibacterial functional layer (with a reasonable proportion of a nanosilver composite, a titanium dioxide photocatalyst, a polyurethane/acrylic resin matrix, and a silane coupling agent), the problems of poor adhesion of the existing antibacterial coating and easy loss of antibacterial components are solved, and the bonding strength between the antibacterial layer and the substrate is significantly improved (peeling strength≥3.5 N/mm). Broad-spectrum antibacterial performance is achieved (the 24-hour bacteriostasis rate against E. coli and Staphylococcus aureus is >99.9%), and food safety requirements are met. Furthermore, the composite panel still maintains an antibacterial rate of more than 95% after 100 cleaning cycles, demonstrating excellent durability. The process has strong compatibility, is suitable for a plurality of substrates such as metals (e.g., stainless steel, aluminum alloy) and non-metals (e.g., wood, density board), broadens the application range, and is particularly suitable for surface protection of bathroom appliances, pet products, and household products.

According to embodiments of the second aspect of the present invention, a method for preparing a composite panel with persistent antibacterial and sterilizing functions, including:
A. preparation of raw materials;
a. base film;
1) selecting a PET (polyethylene terephthalate), PP (polypropylene) or PC (polycarbonate) film with a thickness of 0.05-0.5 mm;
2) the base film should have good mechanical properties and chemical stability to ensure the adhesion of an antibacterial coating;
b. antibacterial coating materials;
1) a nanosilver composite: particle size of 10-50 nm, purity of ≥99.9%;
2) a titanium dioxide photocatalyst: particle size of 20-50nm, purity of ≥99%;
3) a polyurethane/acrylic resin matrix: solid content of ≥50%, moderate viscosity;
4) a silane coupling agent: KH550 or KH570, used to improve the bonding performance between the coating and the substrate;
c. substrates;
1) a metal substrate: stainless steel, aluminum alloy, and the like; the surface should be clean and free of oil stains;
2) a non-metallic substrate: wood, density board, and the like; the surface should be flat and free of cracks;
B. preparation of an antibacterial functional layer;
d. base film treatment;
1) cutting the base film to a required size and ensuring that the surface is clean and dust-free;
2) if necessary, pre-treating the base film (e.g., corona treatment) to improve the adhesion of the coating;
e. coating preparation;
1) mixing process: uniformly mixing a nanosilver composite, a titanium dioxide photocatalyst, a polyurethane/acrylic resin matrix and a silane coupling agent in percentage by weight (1-5% of the nanosilver composite, 3-8% of the titanium dioxide, 85-95% of the resin matrix, 0.5-2% of the coupling agent);
2) stirring conditions: stirring at 500-1000 rpm at room temperature 30-60 minutes to ensure that all components are fully dispersed;
f. coating process;
1) coating method: using micro gravure coating or slot die extrusion coating to uniformly coat the antibacterial coating on the surface of the base film;
2) coating thickness: controlling the coating thickness within a range of 0.01-0.1 mm to ensure the balance between antibacterial performance and coating adhesion;
3) drying conditions: drying at 60-80 °C for 10-30 minutes after coating to remove the solvent;
C. substrate surface treatment;
g. metal substrate treatment;
1) sandblasting treatment: performing sandblasting using an abrasive with a particle size of 80-120 mesh until the surface roughness reaches Sa 2.5 to enhance coating adhesion;
2) passivation treatment: treating the surface with a passivating agent (e.g., a chromate solution) for 5-10 minutes to improve corrosion resistance, then rinsing with deionized water and drying;
h. non-metallic substrate treatment;
1) plasma treatment: performing plasma treatment with a power of 100-500 W for a period of 3-120 seconds to improve surface energy and adhesion;
2) cleaning treatment: cleaning the substrate surface with a neutral detergent before treatment to remove oil and dust;
D. composite processing;
i. hot pressing lamination;
1) temperature control:
2) metal substrate: temperature of preheating zone 80-100 °C, composite temperature 90-110 °C;
3) non-metal substrate: temperature of preheating zone 60-80 °C, composite temperature 70-90 °C;
4) pressure control: composite pressure 0.5-2 MPa, pressure holding time 30-120 s;
5) equipment requirement: using a hot press equipped with temperature sensors and pressure sensors to ensure accurate control of process parameters;
j. adhesive bonding lamination;
1) adhesive agent selection: using a two-component polyurethane adhesive, with a coating amount of 15-30 g/m²;
2) coating method: adopting roller coating or spraying to ensure uniform distribution of the adhesive agent;
3) curing conditions: curing at room temperature for 24 hours or curing at 60 °C for 2 hours.

The method for preparing a composite panel with persistent antibacterial and sterilizing functions according to embodiments of the present invention has at least the following beneficial effects: by selecting a PET, PP or PC film as a base film, and combing the optimized formula of a nano-silver composite, a titanium dioxide photocatalyst, a polyurethane/acrylic resin matrix and a silane coupling agent, the prepared antibacterial functional layer not only has excellent antibacterial performance (the 24-hour bacteriostatic rate against E. coli and Staphylococcus aureusis >99.9 %), but also has high bonding strength with the substrate (peeling strength≥3.5 N/mm), effectively solving the problems of easy coating peeling and easy loss of antibacterial components in the prior art. Meanwhile, through surface pretreatment processes such as sandblasting, passivation and plasma treatment, the bonding performance between metal and non-metal substrates and the antibacterial layer is significantly improved, ensuring the durability of the composite panel in high-frequency contact and cleaning cycle scenarios (the antibacterial rate remains more than 95% after 100 cleaning cycles). In addition, the preparation process of the present invention has strong compatibility, is suitable for a plurality of substrates (such as stainless steel, aluminum alloy, wood, density board, etc.), broadens the application range, is particularly suitable for the surface protection of bathroom appliances, pet supplies and household products; therefore, the present invention has a significant market application value and promotion prospects.

The additional aspects and advantages of the present invention will be partially given in the following description, partially become obvious from the following description, or be understood through the practice of the present invention.

### DETAILED DESCRIPTION OF THE EMBODIMENTS

In the description of the present invention, “a plurality of” means one or more, “multiple” means more than two, “greater than”, “less than”, “exceeding” and the like are understood as not including the number itself, and “above”, “below”, “within” and the like are understood as including the number itself. If “first”, “second” are descried, it is only used to distinguish technical features and cannot be understood as indicating or implying relative importance, or implicitly indicating the number of the indicated technical features, or implicitly indicating the sequence of the indicated technical features.

In the description of the present invention, unless otherwise clearly defined, words and expressions such as “setting/set”, “mounting/mounted”, “connecting/connected” should be understood in a broad sense, and those skilled in the art can reasonably determine the specific meanings of the above words and expressions in the present invention in combination with the specific content of the technical solution.

A composite panel with persistent antibacterial and sterilizing functions according to embodiments of the first aspect of the present invention, including: a substrate and an antibacterial functional layer; the antibacterial functional layer is composed of the following components mixed in percentage by weight: 1-5% of a nanosilver composite, 3-8% of a titanium dioxide photocatalyst, 85-95% of a polyurethane/acrylic resin matrix, and 0.5-2% of a silane coupling agent. By adding the nano-silver composite and the titanium dioxide photocatalyst to the antibacterial functional layer, the composite panel of the present invention can effectively inhibit and kill a variety of bacteria and fungi, including E. coli and Staphylococcus aureus, and the 24-hour bacteriostatic rate exceeds 99.9%. This characteristic makes the composite panel particularly suitable for places with high hygiene requirements, such as hospitals, food processing places, public toilets, etc. The use of polyurethane/acrylic resin matrix and silane coupling agent significantly improves the bonding strength between the antibacterial functional layer and the substrate, and the peeling strength reaches more than 3.5 N/mm. This high bonding strength ensures that the antibacterial layer will not peel off during long-term use and frequent cleaning, thereby ensuring the durability of the antibacterial effect.

According to some embodiments of the present invention, the substrate is a metal substrate or a non-metal substrate. The metal substrate includes a stainless steel and an aluminum alloy, and the non-metal substrate includes a wood and a density board. The composite panel of the present invention is suitable for a variety of substrates, including metals (such as a stainless steel and an aluminum alloy) and non-metals (such as a wood and a density board). This wide applicability enables the composite panel to be applied to a variety of different products and scenarios, such as bathroom appliances, pet supplies, home decoration, etc. The hot pressing and adhesive lamination processes adopted in the preparation method are highly compatible with the existing production process, which is convenient for large-scale industrial production. Meanwhile, the precise control of process parameters ensures the consistency of product quality.

According to embodiments of the present invention, a composite panel with persistent antibacterial and sterilizing functions has at least the following beneficial effects: By optimizing the formula of the antibacterial functional layer (with a reasonable proportion of a nanosilver composite, a titanium dioxide photocatalyst, a polyurethane/acrylic resin matrix, and a silane coupling agent), the problems of poor adhesion of the existing antibacterial coating and easy loss of antibacterial components are solved, and the bonding strength between the antibacterial layer and the base material is significantly improved (peeling strength of ≥3.5 N/mm). Broad-spectrum antibacterial performance is achieved (the 24-hour bacteriostasis rate against E. coli and Staphylococcus aureus is >99.9%), and food safety requirements are met. Furthermore, the composite panel still maintains an antibacterial rate of >95% after 100 cleaning cycles, demonstrating excellent durability. The process has strong compatibility, is suitable for a plurality of substrates such as metals (e.g., stainless steel, aluminum alloy) and non-metals (e.g., wood, density board), broadens the application range, and is particularly suitable for surface protection of bathroom appliances, pet products, and household products.

According to embodiments of the second aspect of the present invention, a method for preparing a composite panel with persistent antibacterial and sterilizing functions, including:
A. preparation of raw materials;
a. base film;
1) select a PET (polyethylene terephthalate), PP (polypropylene) or PC (polycarbonate) film with a thickness of 0.05-0.5 mm;
2) the base film should have good mechanical properties and chemical stability to ensure the adhesion of an antibacterial coating;
b. antibacterial coating materials;
1) a nanosilver composite: particle size of 10-50 nm, purity of ≥99.9%;
2) a titanium dioxide photocatalyst: particle size of 20-50nm, purity of ≥99%;
3) a polyurethane/acrylic resin matrix: solid content of ≥50%, moderate viscosity;
4) a silane coupling agent: KH550 or KH570, used to improve the bonding performance between the coating and the substrate;
c. substrates;
1) a metal substrate: stainless steel, aluminum alloy, and the like; the surface should be clean and free of oil stains;
2) a non-metallic substrate: wood, density board, and the like; the surface should be flat and free of cracks;
B. preparation of an antibacterial functional layer;
d. base film treatment;
1) cut the base film to a required size and ensure that the surface is clean and dust-free;
2) if necessary, pre-treat the base film (e.g., corona treatment) to improve the adhesion of the coating;
e. coating preparation;
1) mixing process: uniformly mix a nanosilver composite, a titanium dioxide photocatalyst, a polyurethane/acrylic resin matrix and a silane coupling agent in percentage by weight (1-5% of the nanosilver composite, 3-8% of the titanium dioxide, 85-95% of the resin matrix, 0.5-2% of the coupling agent);
2) stirring conditions: stir at 500-1000 rpm at room temperature 30-60 minutes to ensure that all components are fully dispersed;
f. coating process;
1) coating method: use micro gravure coating or slot die extrusion coating to uniformly coat the antibacterial coating on the surface of the base film;
2) coating thickness: control the coating thickness within a range of 0.01-0.1 mm to ensure the balance between antibacterial performance and coating adhesion;
3) drying conditions: dry at 60-80 °C for 10-30 minutes after coating to remove the solvent;
C. substrate surface treatment;
g. metal substrate treatment;
1) sandblasting treatment: perform sandblasting using an abrasive with a particle size of 80-120 mesh until the surface roughness reaches Sa2.5 to enhance coating adhesion;
2) passivation treatment: treat the surface with a passivating agent (e.g., a chromate solution) for 5-10 minutes to improve corrosion resistance, then rinsing with deionized water and drying;
h. non-metallic substrate treatment;
1) plasma treatment: perform plasma treatment with a power of 100-500 W for a period of 3-120 seconds to improve surface energy and adhesion;
2) cleaning treatment: clean the substrate surface with a neutral detergent before treatment to remove oil and dust;
D. composite processing;
i. hot pressing lamination;
1) temperature control:
   2) metal substrate: temperature of preheating zone 80-100 °C, composite temperature 90-110 °C;
   3) non-metal substrate: temperature of preheating zone 60-80 °C, composite temperature 70-90 °C;
   4) pressure control: composite pressure 0.5-2 MPa, pressure holding time 30-120 s;
5) equipment requirement: use a hot press equipped with temperature sensors and pressure sensors to ensure accurate control of process parameters;
j. adhesive bonding lamination;
1) adhesive agent selection: use a two-component polyurethane adhesive, with a coating amount of 15-30 g/m²;
2) coating method: adopt roller coating or spraying to ensure uniform distribution of the adhesive agent;
3) curing conditions: cure at room temperature for 24 hours or cure at 60 °C for 2 hours.

The method for preparing a composite panel with persistent antibacterial and sterilizing functions according to embodiments of the present invention has at least the following beneficial effects: by selecting a PET, PP or PC film as a base film, and combing the optimized formula of a nano-silver composite, a titanium dioxide photocatalyst, a polyurethane/acrylic resin matrix and a silane coupling agent, the prepared antibacterial functional layer not only has excellent antibacterial performance (the 24-hour bacteriostatic rate against E. coli and Staphylococcus aureusis >99.9 %), but also has high bonding strength with the substrate (peeling strength≥3.5 N/mm), effectively solving the problems of easy coating peeling and easy loss of antibacterial components in the prior art. Meanwhile, through surface pretreatment processes such as sandblasting, passivation and plasma treatment, the bonding performance between metal and non-metal substrates and the antibacterial layer is significantly improved, ensuring the durability of the composite panel in high-frequency contact and cleaning cycle scenarios (the antibacterial rate remains more than 95% after 100 cleaning cycles). In addition, the preparation process of the present invention has strong compatibility, is suitable for a plurality of substrates (such as stainless steel, aluminum alloy, wood, density board, etc.), broadens the application range, is particularly suitable for the surface protection of bathroom appliances, pet supplies and household products; therefore, the present invention has a significant market application value and promotion prospects.

The embodiments of the present invention are described in detail above, but the present invention is not limited to the above embodiments. Various changes can be made within the knowledge scope of those of ordinary skill in the art without departing from the purpose of the present invention.

What is claimed is:

1. A composite panel with persistent antibacterial and sterilizing functions comprising:
a substrate and an antibacterial functional layer, wherein the antibacterial functional layer is composed of the following components mixed in percentage by weight: 1-5% of a nanosilver composite, 3-8% of a titanium dioxide photocatalyst, 85-95% of a polyurethane/acrylic resin matrix, and 0.5-2% of a silane coupling agent.

2. The composite panel with persistent antibacterial and sterilizing functions according to claim 1, wherein the substrate is a metal substrate or a non-metal substrate, the metal substrate comprises a stainless steel and an aluminum alloy, and the non-metal substrate comprises a wood and a density board.

3. A method for preparing a composite panel with persistent antibacterial and sterilizing functions, comprising:
A. preparation of raw materials;
a. base film;
1) selecting a PET (polyethylene terephthalate), PP (polypropylene) or PC (polycarbonate) film with a thickness of 0.05-0.5mm;
2) the base film should have good mechanical properties and chemical stability to ensure the adhesion of an antibacterial coating;
b. antibacterial coating materials;
1) a nanosilver composite: particle size of 10-50 nm, purity of ≥99.9%;
2) a titanium dioxide photocatalyst: particle size of 20-50 nm, purity of ≥99%;
3) a polyurethane/acrylic resin matrix: solid content of ≥50%, moderate viscosity;
4) a silane coupling agent: KH550 or KH570, used to improve the bonding performance between the coating and the substrate;
c. substrates;
1) a metal substrate: stainless steel, aluminum alloy, and the like; the surface should be clean and free of oil stains;
2) a non-metallic substrate: wood, density board, and the like; the surface should be flat and free of cracks;
B. preparation of an antibacterial functional layer;
d. base film treatment;
1) cutting the base film to a required size and ensuring that the surface is clean and dust-free;
2) if necessary, pre-treating the base film (e.g., corona treatment) to improve the adhesion of the coating;
e. coating preparation;
1) mixing process: uniformly mixing a nanosilver composite, a titanium dioxide photocatalyst, a polyurethane/acrylic resin matrix and a silane coupling agent in percentage by weight (1-5% of the nanosilver composite, 3-8% of the titanium dioxide, 85-95% of the resin matrix, 0.5-2% of the coupling agent);
2) stirring conditions: stirring at 500-1000 rpm at room temperature 30-60 minutes to ensure that all components are fully dispersed;
f. coating process;
1) coating method: using micro gravure coating or slot die extrusion coating to uniformly coat the antibacterial coating on the surface of the base film;
2) coating thickness: controlling the coating thickness within a range of 0.01-0.1 mm to ensure the balance between antibacterial performance and coating adhesion;
3) drying conditions: drying at 60-80 °C for 10-30 minutes after coating to remove the solvent;
C. substrate surface treatment;
g. metal substrate treatment;
1) sandblasting treatment: performing sandblasting using an abrasive with a particle size of 80-120 mesh until the surface roughness reaches Sa2.5 to enhance coating adhesion;
2) passivation treatment: treating the surface with a passivating agent (e.g., a chromate solution) for 5-10 minutes to improve corrosion resistance, then rinsing with deionized water and drying;
h. non-metallic substrate treatment;
1) plasma treatment: performing plasma treatment with a power of 100-500 W for a period of 3-120 seconds to improve surface energy and adhesion;
2) cleaning treatment: cleaning the substrate surface with a neutral detergent before treatment to remove oil and dust;
D. composite processing;
i. hot pressing lamination;
1) temperature control:
2) metal substrate: temperature of preheating zone 80-100 °C, composite temperature 90-110 °C;
3) non-metal substrate: temperature of preheating zone 60-80 °C, composite temperature 70-90 °C;
4) pressure control: composite pressure 0.5-2 MPa, pressure holding time 30-120 s;
5) equipment requirement: using a hot press equipped with temperature sensors and pressure sensors to ensure accurate control of process parameters;
j. adhesive bonding lamination;
1) adhesive agent selection: using a two-component polyurethane adhesive, with a coating amount of 15-30 g/m²;
2) coating method: adopting roller coating or spraying to ensure uniform distribution of the adhesive agent;
3) curing conditions: curing at room temperature for 24 hours or curing at 60 °C for 2 hours.
